(19) United States
(12) Patent Application Publication
(10) Pub. No.: US 2015/0290749 A1
(43) Pub. Date: Oct. 15, 2015

(54) THERMAL CUTTING SYSTEM

(71) Applicant: MURATA MACHINERY, LTD., Kyoto-shi, Kyoto (JP)

(72) Inventor: Daisuke Katsuyama, Inuyama-shi (JP)

(73) Assignee: MURATA MACHINERY, LTD., Kyoto-shi, Kyoto (JP)

(21) Appl. No.: 14/439,780

(22) PCT Filed: Oct. 10, 2013
(86) PCT No.: PCT/JP2013/077558

§ 371 Date: Apr. 30, 2015

(30) Foreign Application Priority Data
Nov. 13, 2012 (JP) 2012-249092

(51) Int. Cl. B23K 37/047; B23K 37/04

(52) U.S. Cl. CPC B23K 37/047; B23K 37/0408

(57) ABSTRACT

A thermal cutting system includes a thermal cutting machine, a work lifting device and a component carry device. The thermal cutting machine includes a work support table including work support sections that support a sheet material workpiece from below and have a pin support shape or a serrated shape. The thermal cutting machine thermally cuts a component part from the sheet material workpiece then placed on the work support table. The work lifting device lifts the sheet material workpiece, which has been thermally cut, from the work support table. The component part carry device picks up the component part from the sheet material workpiece, which has been lifted by the work lifting device, and then carries it to the outside of the cutting machine.

### CROSS REFERENCE TO THE RELATED APPLICATION

This application is based on and claims Convention priority to Japanese patent application No. 2012-249092, filed Nov. 13, 2012, the entire disclosure of which is herein incorporated by reference as a part of this application.

### BACKGROUND OF THE INVENTION

1. Field of the Invention

The present invention relates to a thermal cutting system for cutting a plate-shaped workpiece or a sheet material workpiece with the use of a thermal cutting machine such as, for example, a laser beam cutting machine or a plasma arc cutting machine.

2. Description of the Related Art

Generally in a thermal cutting machine such as, for example, a laser beam cutting machine or a plasma arc cutting machine, a sheet material workpiece is produced after the cutting process is carried out in the following manner. Namely, the sheet material workpiece, on which the cutting process has been worked to cut a component part from the work at the processing station of the thermal cutting machine, is moved to a retracted position neighboring the processing station. Subsequently, as shown in FIG. 11, at the retracted position, only the component part cut from the sheet material workpiece is picked up by a sheet material carrier body 34 having a work suction device such as, for example, a suction pad 36, and the component part W1 is subsequently carried to the outside of the thermal cutting machine. After the component part W1 has been carried in the manner described above, the remaining material W2, which is the sheet material workpiece from which the component parts have been removed, is delivered to the outside of the thermal cutting machine by the sheet material carrier body 34 or any suitable means (not shown).

As another carry method, JP Laid-open Patent Publication No. H11-254165 discloses carrying the component part together with the remaining material. In such a case, the need exists in that after the sheet material workpiece has been carried, the component and the remaining material have to be manually sorted.

As shown in, for example, FIG. 11, a work support table 12 on which the sheet material workpiece W is placed supports the sheet material workpiece W from below by a plurality of work support sections 33. In the example as shown, a plurality of work support plates 12a, having the plurality of the work support sections 13 linearly disposed, are juxtaposed in a direction parallel to the direction of disposition of the work support sections 13. The reason for the work support table 12 is to avoid, as much as possible, the possibility of the sheet material workpiece W and the work support table 12 being thermally welded or melted under the influence of heat, which may occur during the thermal cutting process.

It has, however, been found that even though the work support table 12 is so constructed as described above, the thermal welding or melting of the sheet material workpiece W and the work support table 12 together cannot be avoided completely. As shown in FIG. 12, it may occur that in the event of the thermal welding of a component part W1 and the work support plate 12a of the work support table 12 takes place at a welding portion M, the component part W1 can no longer be picked up by the sheet material carrier body 34.

Also, if the work support table 12 has the construction discussed above, particularly where the component part W1 has a dimension smaller than the space or interval of the work support plate 12a, it may occur that the component part W1 may fall in between the neighboring two work support plates 12a, as shown in FIG. 13, when the suction pad 36 of the sheet material carrier body 34 is pressed to the component part W1 from above to pick up such component part W1. While the component part W1 is supported by the remaining material W2 with its cut faces contacting the remaining material W2, the force of support by this contact, that is, the force of bearing the component part W1 through this contact, is so small that the component part W1 may fall down by the effect of a pressing force of the suction pad 36. Once the component part W1 falls down, the component part W1 is no longer picked up by the sheet material carrier body 34.

### SUMMARY OF THE INVENTION

In view of the foregoing, preferred embodiments of the present invention provide a thermal cutting system capable of assuredly picking up and carrying a component part thermally cut from a sheet material workpiece.

A preferred embodiment of the present invention provides a thermal cutting system including a thermal cutting machine, which includes a work support table including a plurality of work support sections configured to support a sheet material workpiece from below, each of the work support sections has a pin support shape or a serrated shape, and the thermal cutting machine is operable to thermally cut a component part from the sheet material workpiece then placed on the work support table. The thermal cutting system includes a work lifting device configured to lift the sheet material workpiece, which has been thermally cut, from the work support table, and a component part carry device configured to pick up the component part from the sheet material workpiece lifted by the work lifting device and then carry the component part to the outside of the cutting machine. The work support section referred to above may be of a type having a certain surface area so that the sheet material workpiece is supported from below.

According to a preferred embodiment of the present invention, after the thermal cutting machine cuts the component part from the sheet material workpiece placed on the work support table, the work lifting device lifts the sheet material workpiece from the work support table. Accordingly, even though a portion of the sheet material workpiece is thermally welded to the work support table under the influence of heat evolved during the cutting process, a thermally welding portion so formed is disjoined. Subsequently, the component part carry device picks up the component part from the sheet material workpiece lifted by the work lifting device, and then delivers it to the outside of the thermal cutting machine. Even though at the time the component carry device picks up the component part, a portion of the component carry device is pressed from above against the component part, the component part is supported from below by the work lifting device, and therefore, there is no possibility that the component part may fall in between the work support sections of the work support table. In view of the above, the component part, cut from the sheet material workpiece via the cutting process, is assuredly picked up and is then delivered.

In a preferred embodiment of the present invention, the work lifting device preferably includes a plurality of elevating elements which are brought into contact with an undersurface of the sheet material workpiece, and the elevating elements are capable of being moved up and down at a location between the work support sections of the work support table. If the work lifting device includes the plurality of elevating elements, with each of the elevating elements positioned between the work support sections of the work support table which have a pin support shape or a serrated shape, the sheet material workpiece is lifted from the work support table.

In another preferred embodiment of the present invention, the work support table preferably is changeable in position between a processing position, at which the thermal cutting machine performs a cutting process on the sheet material workpiece, and a retracted position spaced a distance from the processing position, in which case the work lifting device is capable of moving in and out below the work support table then held at the retracted position, and the lifting device lifts the sheet material workpiece on the work support table when the work lifting device is positioned below the work support table. According to this structural feature, while the work lifting device and the component part carry device perform the carry operation relative to the sheet material workpiece on the work support table then held at the retracted position, the cutting process is performed by the thermal cutting machine relative to the sheet material workpiece on the work support table then held at the processing position and, hence, the processing efficiency is increased.

Any combination of at least two configurations or features, disclosed in the appended claims and/or the specification and/or the accompanying drawings should be construed as included within the scope of the present invention. In particular, any combination of two or more of the appended claims should be equally construed as included within the scope of the present invention.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a front elevational view showing a thermal cutting system designed in accordance with a preferred embodiment of the present invention.

FIG. 2 is a top plan view showing the thermal cutting system.

FIG. 3 is a side view showing a sheet material transport device included in the thermal cutting system.

FIG. 4 is a perspective view showing a work support table included in the thermal cutting system.

FIGS. 5A-5F are explanatory diagrams showing the sequence of replacing a work support table.

FIGS. 6A-6C are explanatory diagrams showing the sequence of positioning of a sheet material workpiece at the time such sheet material workpiece is carried in a thermal cutting machine included in the thermal cutting system.

FIG. 7 is a perspective view showing the work support table, a portion of a work lifting device and the sheet material workpiece all in the thermal cutting system.

FIGS. 8A-8D are explanatory diagrams showing the sequence of picking up a component part from the sheet material workpiece.

FIG. 9 is a perspective view showing a portion of a modified configuration of the work support table.

FIG. 10 is a perspective view showing a portion of a modified configuration of the work lifting device.

FIG. 11 is a perspective view showing the work support table and the sheet material workpiece both included in the conventional thermal cutting system.

FIG. 12 is a diagram showing a state assumed while the component part is picked up from the sheet material workpiece.

FIG. 13 is a diagram showing a different state while the component part is picked up from the sheet material workpiece.

### DETAILED DESCRIPTION OF THE PREFERRED EMBODIMENTS

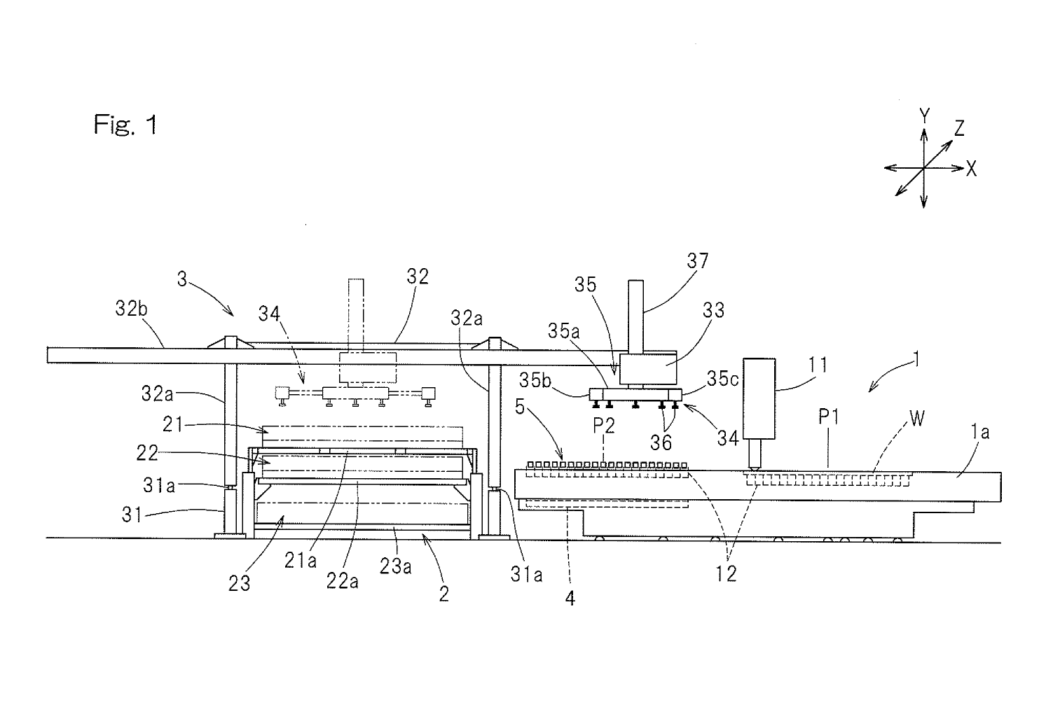

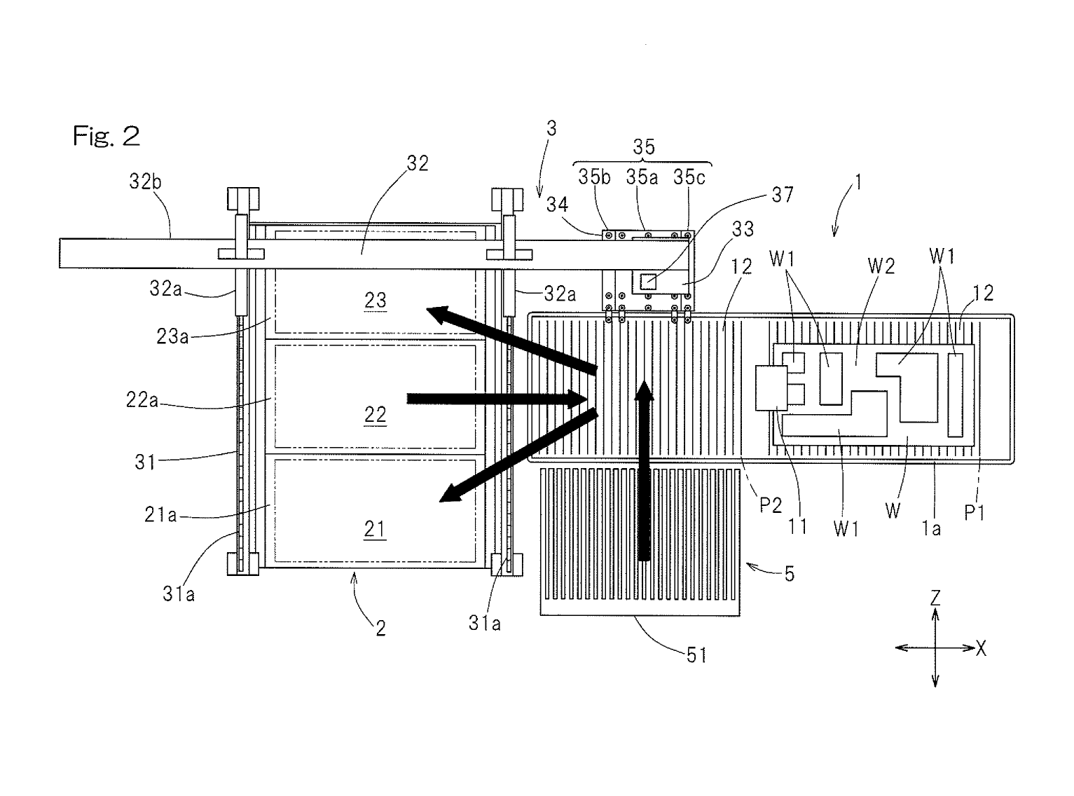

Preferred embodiments of the present invention will now be described in detail with particular reference to the accompanying drawings. FIG. 1 is a front elevational view showing an entire thermal cutting system designed in accordance with a preferred embodiment of the present invention, and FIG. 2 is a top plan view thereof. The illustrated thermal cutting system includes a thermal cutting machine 1 in the form of, for example, a laser beam machine, a sheet material storage device 2 installed laterally next to the thermal cutting machine 1, a sheet material transport device 3 configured to transport various sheet materials successively between the thermal cutting machine 1 and the sheet material storage device 2, a work support device 4 used to position a sheet material workpiece W when the sheet material workpiece W is to be carried in the thermal cutting machine 1, and a work lifting device 5 used to carry a component part W1 from the thermal cutting machine 1. The sheet material transport device 3 is an example of a component carry device and, in the case of the present preferred embodiment now under discussion, the sheet material transport device 3 is configured to include, in addition to a function as the component carry-out device, a function of carrying in the sheet material workpiece W and a function of carrying-out a remaining material W2 of the sheet material workpiece W from which the component part W1 is cut out. It is to be noted that the various sheet materials referred to above indicate the sheet material workpiece, the component part W1 and the remaining material W2.

The thermal cutting machine 1 includes a laser head 11 capable of moving in a forward and rearward direction (Z-axis direction), a leftward and rightward direction (X-axis direction) and an up and down direction (Y-axis direction), and this leaser head 11 performs a cutting process on the sheet material workpiece W while moving in the forward and rearward direction and also in the leftward and rightward direction relative to the sheet material workpiece W, placed on a work support table 12, to irradiate the sheet material workpiece W with a laser beam.

As shown in FIG. 4, the work support table 12 includes a plurality of work support plates 12a arranged in parallel or substantially parallel relation to each other, each of those work support plates 12a including an upper edge portion with a serrated shape. The work support plates 12a include respective lower ends fixed to a base plate 12b. Serrations configuring the serrated shape define work support sections 13 which support the sheet material workpiece W from below. Those work support sections 13 may not be necessarily held in point contact with the sheet material workpiece W and may be of a shape having a certain surface area of contact with the sheet material workpiece W. The work support table 12 is shaped as described above, for the purpose that, by lessening the contact surface area with the sheet material workpiece W, the possibility of the sheet material workpiece W being thermally welded to the work support table 12 under the influence of heat evolved during the cutting process is reduced as much as possible. Portions of the base plate 12b, each delimited between the neighboring work support plates 12a, include a slit 12ba through which a ball support body 42 (as will be described later) can pass.

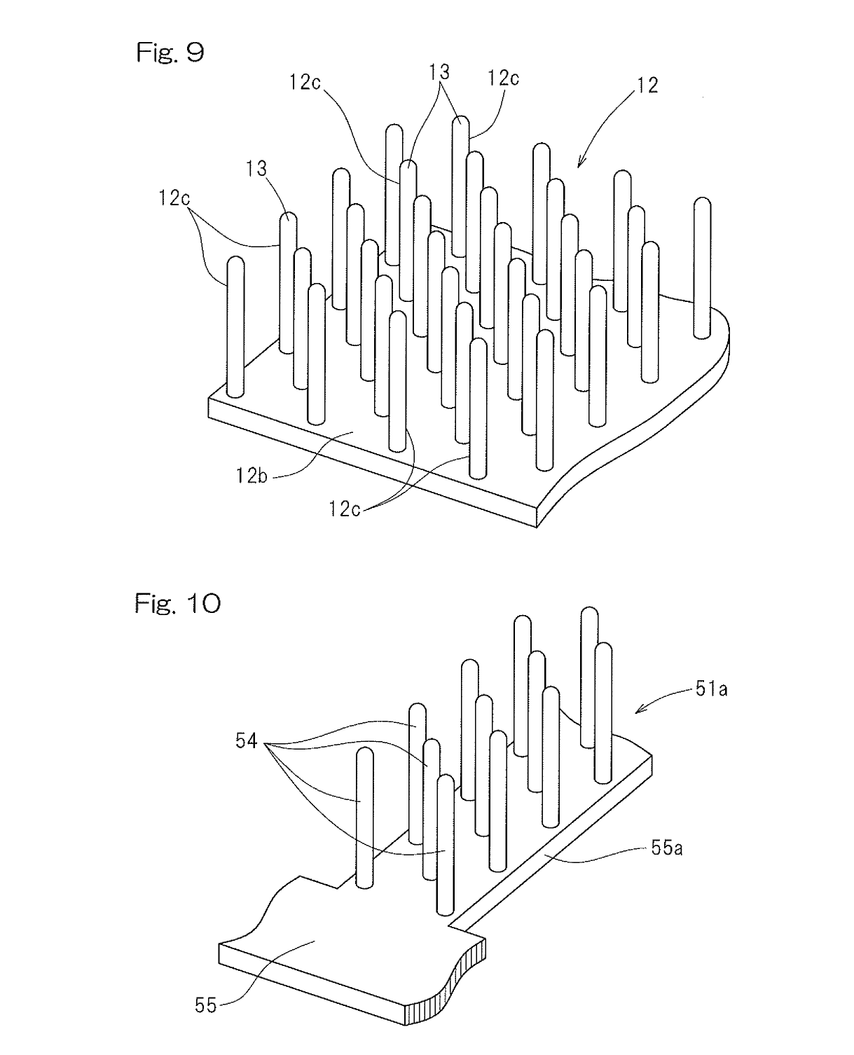

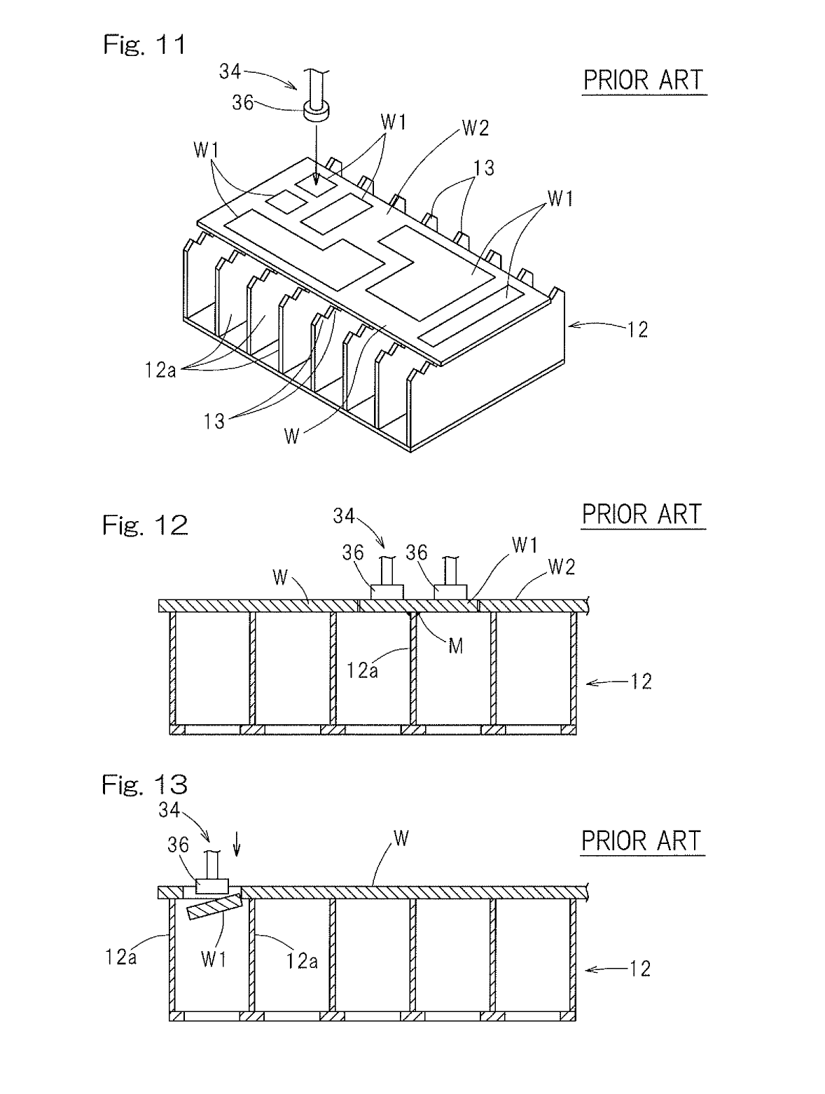

In order to lessen the surface area of contact between the work support table 12 and the sheet material workpiece W, as shown in FIG. 9, the work support table 12 may be shaped to assume a form of a pin support or pin holder in which a plurality of work support pins 12c extend upright from the base plate 12b. In the example as shown in FIG. 9, each of the work support pins 12c includes a tip end so shaped as to represent a semispherical shape. In such case, the semispherically shaped tip ends of the work support pins 12c define the respective work support sections 13 referred to previously.

As shown in FIG. 2, preferably two of the work support table 12 are provided for each of the thermal cutting machines 1. Those two work support tables 12 are changeable in position between a processing position P1, at which the sheet material workpiece W is capable of being thermally cut by the laser head 11, and a retracted position P2 defined between the processing position P1 and the sheet material storage device 2. As a position changing mechanism for the work support table 12, a mechanism (not shown) configured to move horizontally between the processing position P1 and the retracted position P2 and a mechanism (not shown) configured to elevate the work support table 12 at the retracted position P2 are possessed, but those mechanisms are of a known structure and, therefore, the details thereof are not herein set forth.

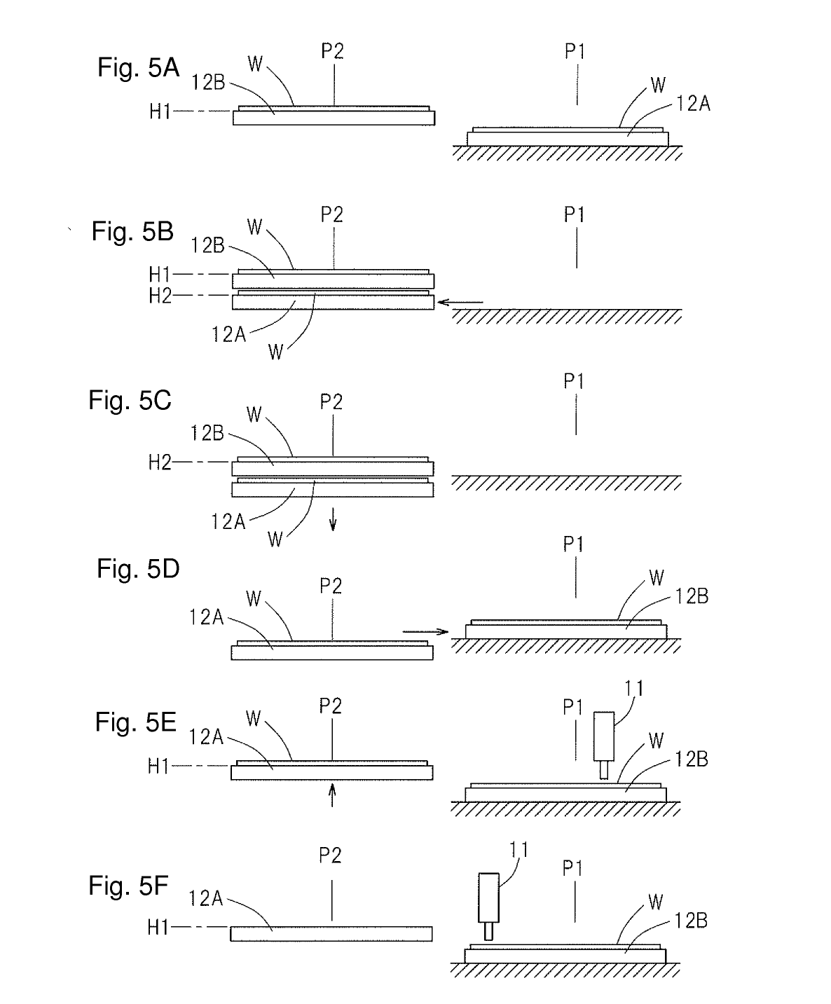

The position changing operation of the two work support tables 12 (first and second work support tables 12A and 12B) are such as shown in FIGS. 5A to 5F. FIG. 5A shows the condition in which the thermal cutting process applied to the sheet material workpiece W placed on the first work support table 12A has been terminated. At this time, the second work support table 12B is held in a standby position at a work carry-in and carry-out height H1 in the retracted position P2, which height H1 is higher than the heightwise level of the processing position P1. An unprocessed sheet material workpiece W, which has not yet been processed, is placed on the second work support table 12B. It is to be noted that the respective heights of the first and second work support tables 12A and 12B at the processing position P1 are fixed.

Upon completion of the cutting process of the perimeter of the component part W1 relative to the sheet material workpiece W, as shown in FIG. 5B, the first work support table 12A is horizontally moved to the retracted position P2 to assume a position immediately beneath the second work support table 12B. The height of the first work support table 12A at this time is a position changing height H2 that is at the same heightwise level as the processing position P1.

Subsequently, as shown in FIG. 5C, the first and second work support tables 12A and 12B descends together and the second work support table 12B assumes the position changing height H2 Then, as shown in FIG. 5D, the second work support table 12B is horizontally moved to the processing position P1.

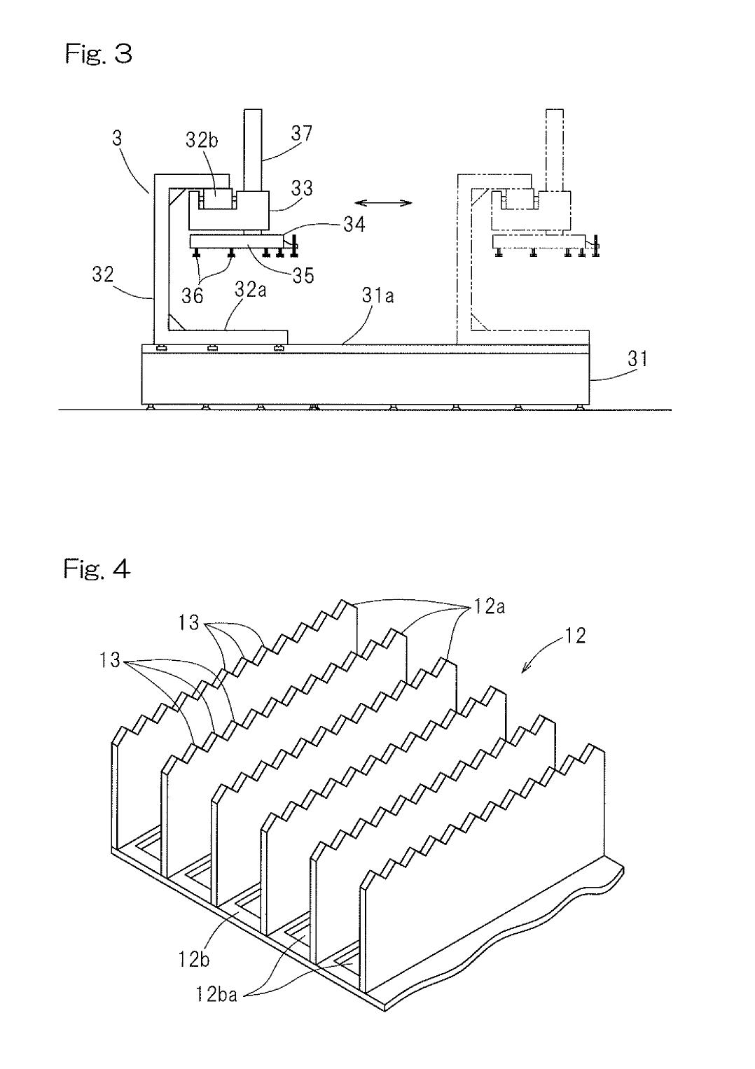

As shown in FIG. 5E, the cutting process is effected to the sheet material workpiece W held on the second work support table 12B at the processing position P1 by the laser head 11. During the cutting process taking place, the first work support table 12A is elevated to the work carry-in and carry-out height H1. Then, via the sheet material transport device 3 (best shown in FIGS. 1 to 3), the remaining material W2 and the component part W1 are carried from the processed sheet material workpiece W on the first work support table 12A to thus establish such a condition as shown in FIG. 5F.

Subsequently, with the unprocessed sheet material workpiece W being carried on the first work support table 12A, the condition shown in FIG. 5A is resumed. It is, however, to be noted that the first work support table 12A and the second work support table 12B are replaced with each other. The details of the carry operations of the various sheet materials performed by the sheet material transport device 3 will be described later.

As shown in FIGS. 1 and 2, the sheet material storage device 2 includes a component part storage 21 configured to store the component part W1, a raw material storage 22 configured to store the sheet material workpiece W which is a raw material, and a remaining material storage 23 configured to store the remaining material W2, and these storages 21, 22 and 23 arranged side by side in the forward and rearward direction. In each of the various storages 21, 22 and 23, the component part W1, the sheet material workpiece W and the remaining material W2 are placed on respective pallets 21a, 22a and 23a.

Referring to Figs. 1 to 3, the sheet material transport device 3 includes a stationary stand 31 placed on a floor surface, a movable stand 32 which extends a distance in the leftward and rightward direction and is mounted on the stationary stand 31 for movement in the forward and rearward direction, a traveling body 33 movably installed along the movable stand 32 and a sheet material carrier body 34 mounted on the traveling body 33 for movement up and down. Accordingly, the sheet material carrier body 34 is capable of moving in three-axis directions including the forward and rearward direction, the leftward and rightward direction and the up and down direction.

Specifically, the stationary stand 31 includes a pair of fixed rails 31a extending along left and right sides of the sheet material storage device 2, and a leg portion 32a of the movable stand 32 is supported for movement along the fixed rails 31a. The movable stand 32 includes a rail 32b extending in the leftward and rightward direction, and the traveling body 33 is installed for movement along this rail 32b.

The sheet material carrier body 34 includes a plurality of suction pads 36 provided in a pad mounting frame 35 and having been arranged forwardly and rearwardly as well as leftwardly and rightwardly, and the sheet material workpiece W is held by those suction pads 36 having been sucked thereby. Each of the suction pads 36 is of, for example, a vacuum suction type and are connected with a suction device (not shown) by means of tubing. The pad mounting frame 35 referred to above includes a main frame 35a and extendable frames 35b and 35c on left and right sides of the main frame 35a. Depending on the shape and the dimension of a sheet material to be held, the extendable frames 35b and 35c are capable of being telescopically adjusted in the leftward and rightward direction relative to the main frame 35a. Also, the pad mounting frame 35 is provided at a lower end of a lifting rod 37 capable of moving up and down relative to the traveling body 33, and hence, the sheet material carrier body 34 is capable of being lifted up or down as the lifting rod 37 is lifted up or down, respectively.

The sheet material transport device 3 performs carry-in and carry-out of the sheet material while the various sheet materials are held and transported by the sheet material carrier body 34. In other words, the sheet material workpiece W is loaded onto the work support table 12 then positioned at the retracted position P2 of the thermal cutting machine 1. Also, from the sheet material workpiece W on the work support table 12 then held at the retracted position P2, the component part W1 is carried to the component part storage 21. In addition, after the component part W1 has been carried, the remaining material W2 is carried to the remaining material storage 23.

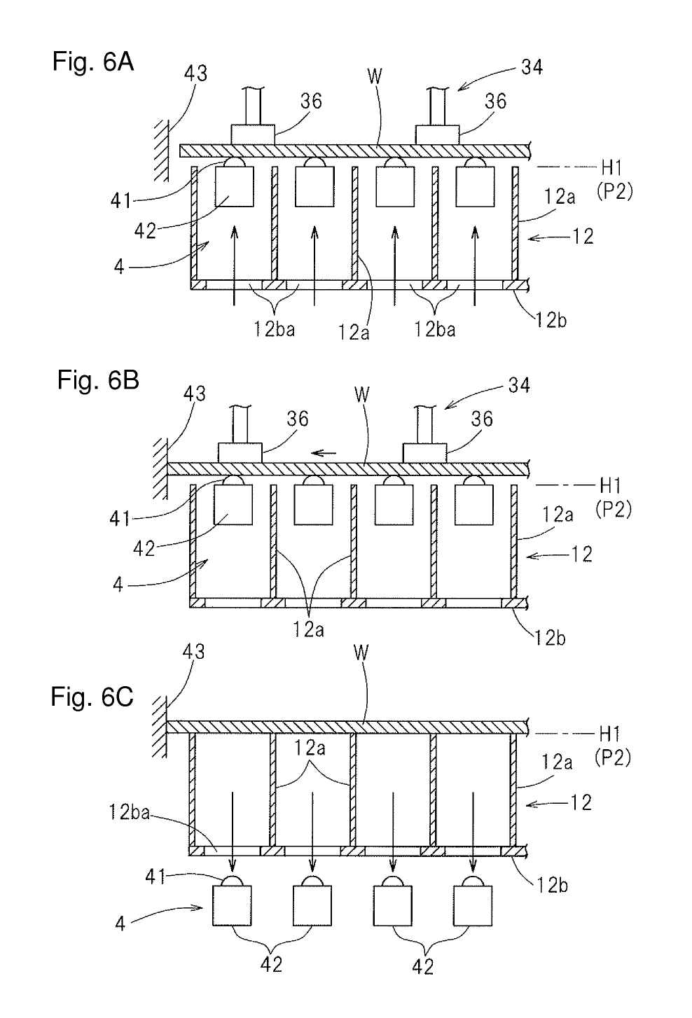

As shown in FIGS. 6A-6C, the work support device 4 includes a plurality of ball support bodies 42 each provided with a ball 41 mounted rotatably on a top surface thereof. Each of the ball support bodies 42 has a shape and a dimension so as to pass through the slit 12ba defined in the base plate 12b of the work support table 12. Each of the ball support bodies 42 is installed on a common elevating member (not shown) and is capable of moving up and down by an elevating mechanism (not shown) together with such lifting member. At an ascended position shown in FIGS. 6A and 6B, an upper end of the ball 41 is protruding upwardly beyond an upper end of the work support plate 12a of the work support table 12 then held at the work carry-in and carry-out height H1.

Positioning of the sheet material workpiece W at the carry-in time is performed in the following manner. Namely, each of the ball support bodies 42 of the work support device 4 passes through the slit 12ba in the work support table 12 then held at the work carry-in and carry-out height H1 at the retracted position P2, and is ascended to a lifted position, followed by placement of the sheet material workpiece W on the balls 41 of the ball support bodies 42 (FIG. 6A). Subsequently, the sheet material workpiece W is horizontally moved by the sheet material carrier body 34 and is brought into contact with a positioning end member 43 (FIG. 6B). The end member 43 is fitted to the frame la of the thermal cutting machine 1 (in FIGS. 1 and 2). When the sheet material workpiece W is brought into contact with the end member 43, the sheet material carrier body 34 releases the sheet material workpiece W, followed by lowering of each of the ball support bodies 42 (FIG. 6C). Accordingly, with the sheet material workpiece W held in a condition as positioned, the sheet material workpiece W is supported by the work support table 12.

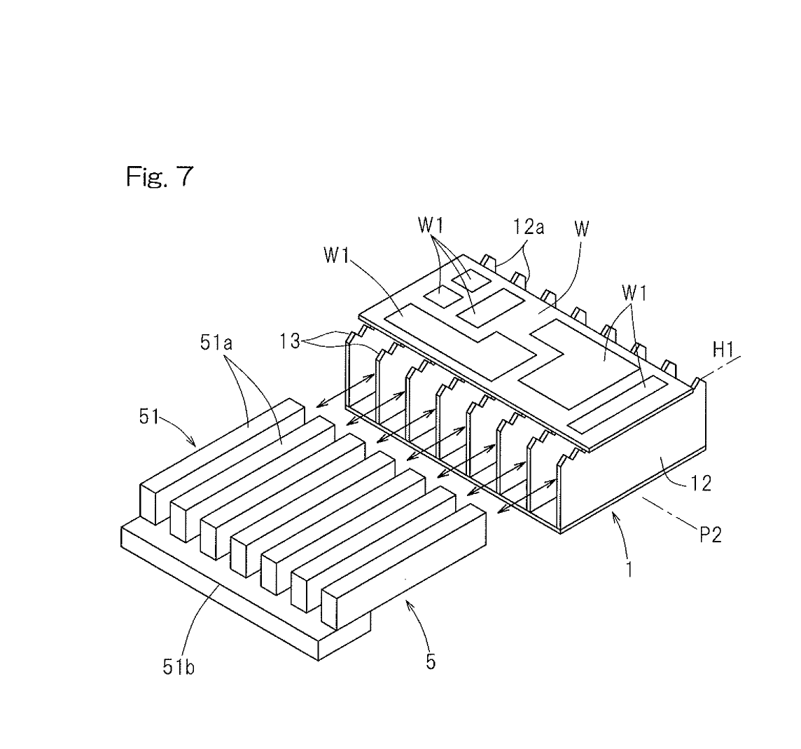

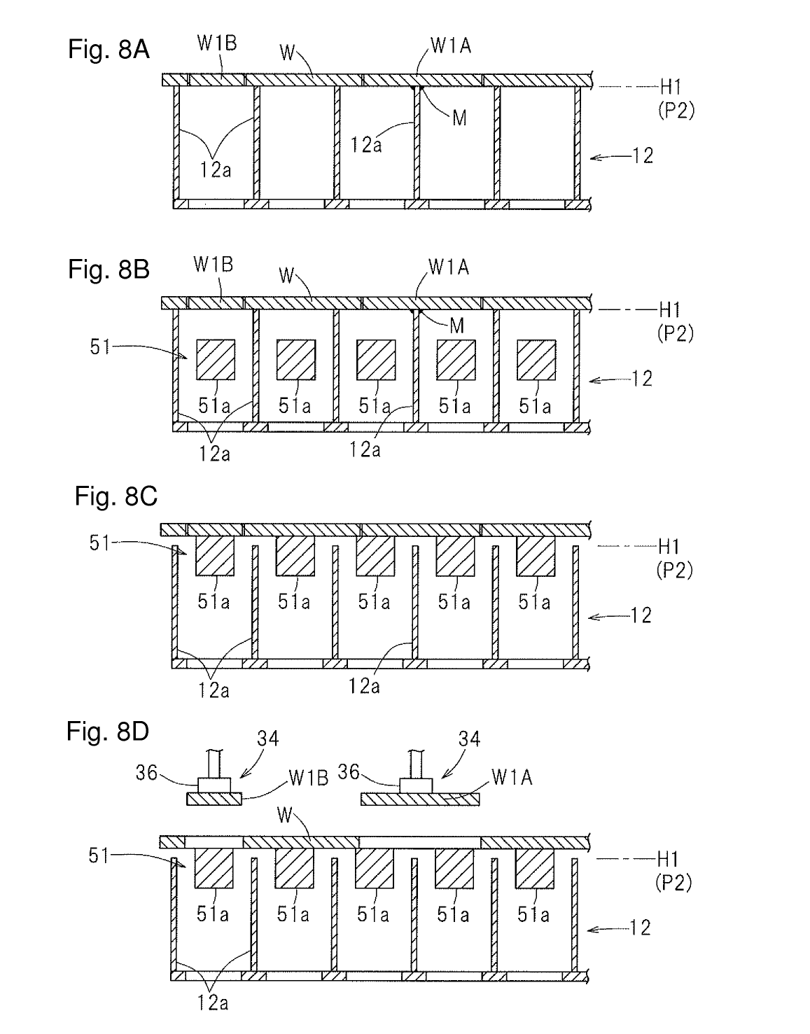

The work lifting device 5 includes, as shown in FIG. 7, a comb-shaped work lifting member 51 including a plurality of elongated elevating elements 51a disposed side by side relative to each other and each extending in a direction forwardly and rearwardly. Each of the elevating elements 51a has a shape and a dimension so as to enable the elevating element 51a to be insertable in between the corresponding neighboring members of the work support plates 12a of the work support table 12 and is connected at a bottom surface side of a rear end thereof with the next adjacent elevating element 51a via a connecting member 51b. The work lifting member 51 is movable by a retracting mechanism (not shown) in the forward and rearward direction for advance and retraction. When the work lifting member 51 is advanced, the elevating element 51a assumes a condition advanced into between the work support plates 12a of the work support table 12 then held at the work carry-in and carry-out height H1 at the retracted position P2. On the other hand, when the work lifting member 51 is retracted, the elevating element 51a assumes a condition escaped from the work support plate 12a. Also, the work lifting member 51 is capable of being moved up and down by an elevating mechanism (not shown). In a condition in which the work lifting member 51 is ascended at the advanced position, an upper end of each of the elevating element 51a assumes a superior position above an upper end of each of the work support plates 12a of the work support table 12 then held at the work carry-in and carry-out height H1 of the retracted position P2, as shown in FIGS. 8C and 8D.

The operation of the work lifting device 5 at the time the component part W1 is picked up will now be described with particular reference the operations shown in in FIG. 8A to 8D.

FIG. 8A illustrates a condition in which the work support table 12 having placed thereon the sheet material workpiece W which has been cut is held at the work carry-in and carry-out height H1 at the retracted position P2. In the operation shown in FIG. 8A, two component parts W1A and W1B have been cut from the sheet material workpiece W. One component part W1A is thermally welded to one of the work support plates 12a of the work support table 12 at a welding portion M. The other component part W1B, although positioned between the neighboring work support plates 12a, is supported by the remaining material W2 while a cut surface in the outer periphery thereof is in contact with the remaining material W2.

From the condition shown in FIG. 8A, the work lifting member 51 is advanced to allow each of the elevating elements 51a to enter in between the work support plates 12a of the work support table 12 (FIG. 8B). Then, the work lifting member 51 ascends to lift the sheet material workpiece W from the work support table 12 (FIG. 8C). Thus, the welding portion M of such one component part W1A is disjoined from the work support plate 12a.

Thereafter, as shown in FIG. 8D, the component parts W1A and W1B are picked up by the sheet material carrier body 34, followed by transport thereof to the component part storage 21 (shown in FIGS. 1 and 2). Since the welding portion M of the component part W1A is disjoined from the work support plate 12a, the component part W1A is easily picked up. Also, since the component part W2B is supported from below by the elevating element 51a, even when the suction pad 36 is pressed from above onto the component part W1B during the suction, the component part W1B will not fall in between the work support plates 12a and is assuredly picked up. In the operation shown in FIG. 8D, the component part W1A and the component part W1B are shown as if they are simultaneously picked up, but in reality the component parts W1A and W1B are separately picked up.

As shown in FIG. 10, the work lifting member 51 of the work lifting device 5 may be of a type including a plurality of pins 54 in which all of the elevating elements 51a are arranged on the same plane. Each of the pins 54 is connected at its lower end with a comb teethed portion 55a of a comb shaped plate 55.

As hereinbefore fully described, the thermal cutting system of various preferred embodiments of the present invention is such that the thermal cutting machine 1 preferably includes the two work support tables 12 and those two work support tables 12 are changeable in position between the processing position P1 and the retracted position P2. Also, the work lifting device 5 is operable to enter beneath the work support table 12 then held at the retracted position P2 and to lift the sheet material workpiece W on the work support table 12, to assist the carrying of the component part W1 by the sheet material transport device 3. According to the configuration hereinabove described, while the carrying operation of the component part W1 is performed by the work lifting device 5 and the sheet material transport device 3 relative to the sheet material workpiece W on the work support table 12 then held at the retracted position P2, the cutting process is effected by the thermal cutting machine 1 on the sheet material workpiece W on the work support table 12 then held at the processing position P1. Hence, the processing efficiency is high.

Although the present invention has been fully described in connection with the preferred embodiments thereof with reference to the accompanying drawings which are used only for the purpose of illustration, various changes and modifications are to be construed as included therein.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-3. (canceled)

4. A thermal cutting system comprising:
a thermal cutting machine which includes a work support table including a plurality of work support sections configured to support a sheet material workpiece from below, each of the work support sections including a pin support shape or a serrated shape, the thermal cutting machine being operable to thermally cut a component part from the sheet material workpiece then placed on the work support table;
a work lifting device configured to lift the sheet material workpiece, which has been thermally cut, from the work support table; and
a component part carry device configured to pick up the component part from the sheet material workpiece lifted by the work lifting device and then carry the component part to outside of the thermal cutting machine.

5. The thermal cutting system as claimed in claim 4, wherein
the work lifting device includes a plurality of elevating elements configured to be brought into contact with an undersurface of the sheet material workpiece; and
the elevating elements are moved up and down at a location between the work support sections of the work support table.

6. The thermal cutting system as claimed in claim 4, wherein
the work support table is changeable in position between a processing position, at which the thermal cutting machine performs a cutting process on the sheet material workpiece, and a retracted position spaced a distance from the processing position;
the work lifting device is capable of moving in and out below the work support table then held at the retracted position; and
the work lifting device lifts the sheet material workpiece on the work support table, when the work lifting device is positioned below the work support table.
